(19) United States
(12) Patent Application Publication
(10) Pub. No.: US 2025/0146561 A1
(43) Pub. Date: May 8, 2025

(54) HIGH-DENSITY ACTUATOR WITH IN-MOTOR TRANSMISSION

(71) Applicant: B-TEMIA INC., St-Augustin-de-Desmaures (CA)

(72) Inventors: Francisco SOUCY, St-Augustin-de-Desmaures (CA); Martin BEAUMONT, St-Augustin-de-Desmaures (CA); Marcus BROOKSHAW, St-Augustin-de-Desmaures (CA); Nathaniel ZOSO, St-Augustin-de-Desmaures (CA)

(21) Appl. No.: 18/838,205

(22) PCT Filed: Feb. 14, 2023
(86) PCT No.: PCT/CA2023/050193

§ 371 Date: Aug. 13, 2024

Related U.S. Application Data
(60) Provisional application No. 63/310,098, filed on Feb. 14, 2022.

(51) Int. Cl. F16H 13/08; F16H 1/32; F16H 57/02

(52) U.S. Cl. CPC F16H 13/08; F16H 1/32; F16H 57/02; F16H 2057/02034; F16H 2057/02073

(57) ABSTRACT

A high-density actuator, comprising: a motor including a stator, a rotor, a rotor hub, rotor bearings, an actuator base, and rolling bearings; and a transmission positioned within the rotor hub. The high-density actuator is configured such that the transmission is located within the inner diameter of the motor. The transmission may be, for example, a cycloidal transmission, a planetary transmission and a harmonic transmission.

### CROSS-REFERENCE TO RELATED APPLICATIONS

This application claims the benefits of U.S. provisional patent application No. 63/310,098 filed on Feb. 14, 2022, which is herein incorporated by reference.

### TECHNICAL FIELD

The present disclosure relates to a high-density actuator with in-motor transmission.

### BACKGROUND

Motors and transmissions are used to activate various devices. In the case of devices such as exoskeletons, anthropomorphic robots and other low volume and high-powered application, it is advantageous that the combination of both components be as compact as possible. This leads to a higher density motor and transmission combination called an actuator. However, traditional transmissions are stacked on the top of the motor casings, which leads to increased thickness of the motor and transmission structure.

Accordingly, there is a need for a high-density, low-profile motor and transmission structure.

### SUMMARY

The present disclosure provides a high-density actuator, comprising:
a motor including a stator, a rotor, a rotor hub, rotor bearings, an actuator base, and rolling bearings; and
a transmission positioned within the rotor hub;
wherein the transmission is located within an inner diameter of the motor.

The present disclosure also provides a high-density actuator wherein the transmission has an overall diameter that is smaller than an inner diameter of the stator and of an inner diameter of the rotor.

The present disclosure further provides a high-density actuator including a cycloidal transmission, a planetary transmission or a harmonic transmission.

The present disclosure also provides a high-density actuator wherein the transmission is a cycloidal transmission including:
a cycloid ring gear configured to rotate within a rotor hub via rotor bearings;
an input shaft configured to follow an eccentric motion guided by a cycloid disk having an outer-face configured to roll within a cycloid ring gear via roller pins; and
output pins, positioned in corresponding openings within the cycloid disk, operatively connecting the cycloid disk to an output shaft, transferring torque from a rotor to the output shaft, further operatively connected to an actuator base via rolling bearings.

The present disclosure further provides a high-density actuator wherein the transmission is a cycloidal transmission including:
a cycloid ring gear configured to rotate within a rotor hub via rotor bearings;
an input shaft configured to follow an eccentric motion guided by a cycloid disk having an outer-face configured to roll within a cycloid ring gear via roller pins; and
output pins, positioned in corresponding openings within the cycloid disk, operatively connecting the cycloid disk to an output shaft, transferring torque from a rotor to the output shaft, further operatively connected to an actuator base via the rolling bearings.

The present disclosure further provides a high-density actuator wherein the transmission is a cycloidal transmission including:
a cycloid ring gear configured to rotate within a rotor hub via rotor bearings;
an input shaft configured to follow an eccentric motion guided by a cycloid disk having an outer-face configured to roll within a cycloid ring gear via roller pins; and
output pins, positioned in corresponding openings within the cycloid disk, operatively connecting the cycloid disk to an output shaft, transferring torque from a rotor to the output shaft, further operatively connected to an actuator base via rolling bearings.

The present disclosure also provides a high-density actuator wherein the transmission is a cycloidal transmission including:
a cycloid ring gear configured to rotate within a rotor hub via rotor bearings;
an input shaft configured to follow an eccentric motion guided by a cycloid disk having an outer-face configured to roll within a cycloid ring gear via roller pins; and
output pins, positioned in corresponding openings within the cycloid disk, operatively connecting the cycloid disk to an output shaft, transferring torque from a rotor to the output shaft, further operatively connected to an actuator base via the rolling bearings.

The present disclosure further provides a high-density actuator wherein the transmission is a cycloidal transmission including:
a cycloid ring gear configured to rotate within a rotor hub via rotor bearings;
an input shaft configured to follow an eccentric motion guided by a cycloid disk having an outer-face configured to roll within a cycloid ring gear via roller pins; and
output pins, positioned in corresponding rolling elements within corresponding openings within the cycloid disk, operatively connecting the cycloid disk to an output shaft, transferring torque from a rotor to the output shaft, further operatively connected to an actuator base via the rolling bearings.

The present disclosure also provides a high-density actuator enclosed within an actuator housing.

### BRIEF DESCRIPTION OF THE FIGURES

Embodiments of the disclosure will be described by way of examples only with reference to the accompanying drawings, in which:

FIG. 1 is a cross-sectional view of the high-density actuator with in-motor transmission using an in-rotor cycloidal transmission in accordance with an illustrative embodiment of the present disclosure;

FIG. 2 is a perspective cross-sectional view of the in-rotor cycloidal transmission of FIG. 1;

FIG. 3 is a top cross-sectional view of the in-rotor cycloidal transmission of FIG. 1; and

FIG. 4 is a perspective exploded view of the in-rotor cycloidal transmission of FIG. 1;

FIG. 5 is a top cross-sectional view of the in-rotor cycloidal transmission in accordance with a first alternative embodiment of the present disclosure;

FIG. 6 is a cross-sectional view of the high-density actuator with in-motor transmission in accordance with a second alternative embodiment of the present disclosure;

FIG. 7 is a top cross-sectional view of the in-rotor cycloidal transmission in accordance with a third alternative embodiment of the present disclosure; and

FIG. 8 is a top cross-sectional view of the in-rotor cycloidal transmission in accordance with a fourth alternative embodiment of the present disclosure.

Similar references used in different Figures denote similar components.

### DETAILED DESCRIPTION

Generally stated, the non-limitative illustrative embodiments of the present disclosure provide a high-density actuator with in-motor transmission. In the illustrative embodiments the in-motor transmission is an in-rotor cycloidal transmission whose overall diameter is smaller than the stator and rotor's inner diameter and is partially or completely inserted into the actuator. Although the disclosed illustrative embodiments are described using an in-rotor cycloidal transmission, it is to be understood that other transmissions can be used as well, for example a planetary transmission or a harmonic transmission.

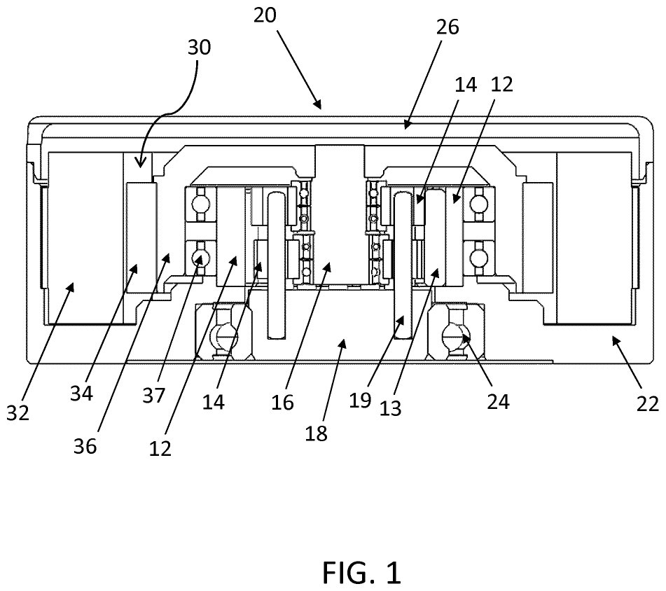

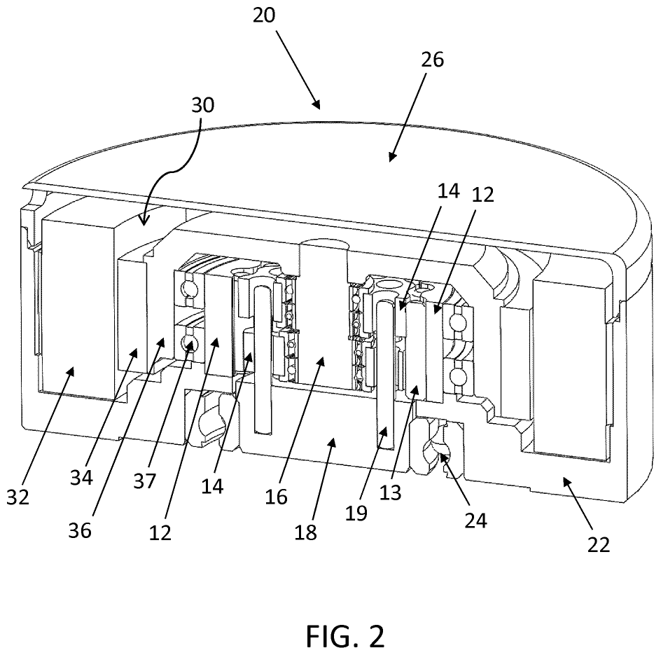

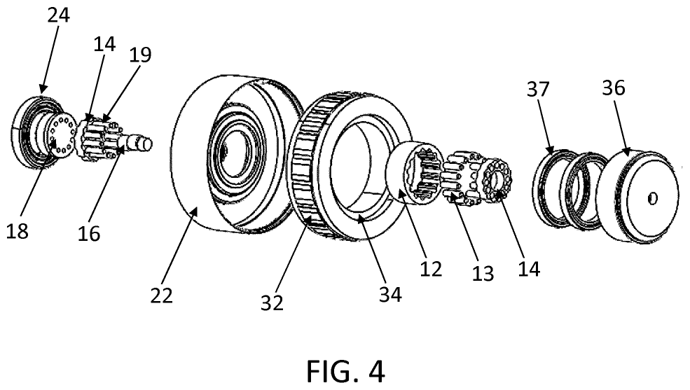

Referring to FIGS. 1 to 4, the high-density actuator 30 in accordance with an illustrative embodiment of the present disclosure includes a stator 32, a rotor 34, and housing 20 having a cycloidal transmission positioned therein. The cycloidal transmission is composed of a cycloidal ring gear 12, roller pins 13, cycloid disk 14, input shaft 16, output shaft 18 and output pins 19.

The cycloidal transmission 12, 13, 14, 16, 18, 19 is positioned within the actuator 30 such that rotor bearings 37 allow the rotor hub 36 to rotate around the cycloid ring gear 12. The input torque of the rotor 34 and rotor hub 36 is transmitted through the input shaft 16. While the input shaft 16 rotates, its center follows an eccentric motion allowing the correct movement from the cycloid disk 14. The cycloid disk's 14 outer-face rolls on the roller pins 13, which provides the transmission of torque to the output pins 19. The output pins 19 are inserted in the output shaft 18, which transfers the torque to the output shaft 18. The output shaft 18 is connected to the actuator housing base 22 via rolling bearings 24. An actuator housing cover 26 secures the actuator 30 and cycloidal transmission 12, 13, 14, 16, 18, 19 within the housing 20.

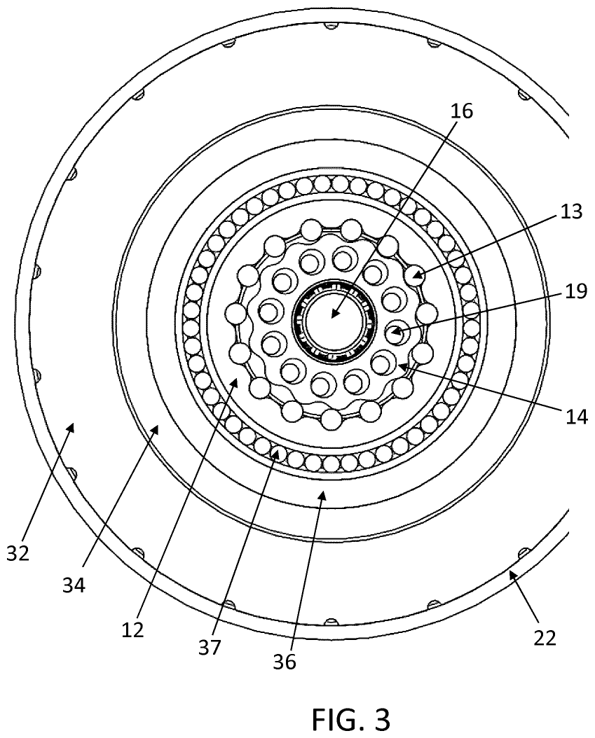

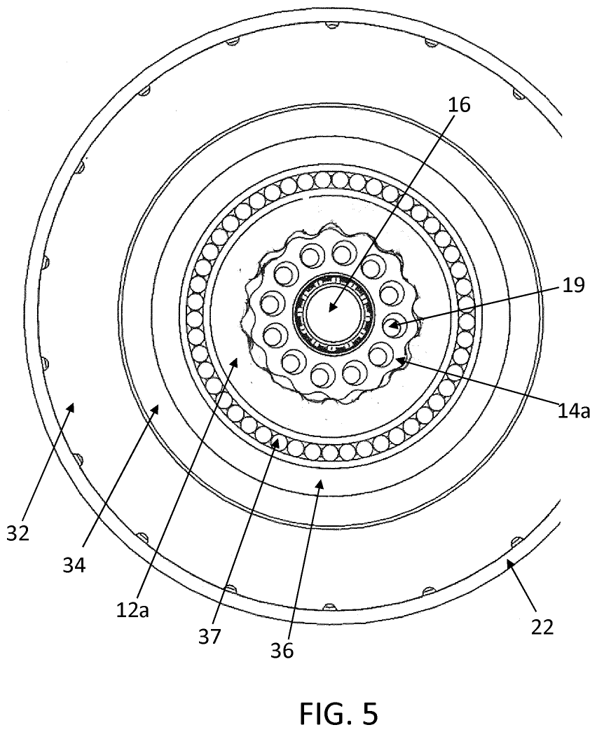

Referring to FIG. 5, in a first alternative embodiment of the high-density actuator 30 with in-motor transmission, the roller pins 13 (see FIG. 3) may be omitted and the shape of the inner part of the cycloidal ring gear 12a and outer face of the cycloid disk 14a adapted to provide corresponding protuberances.

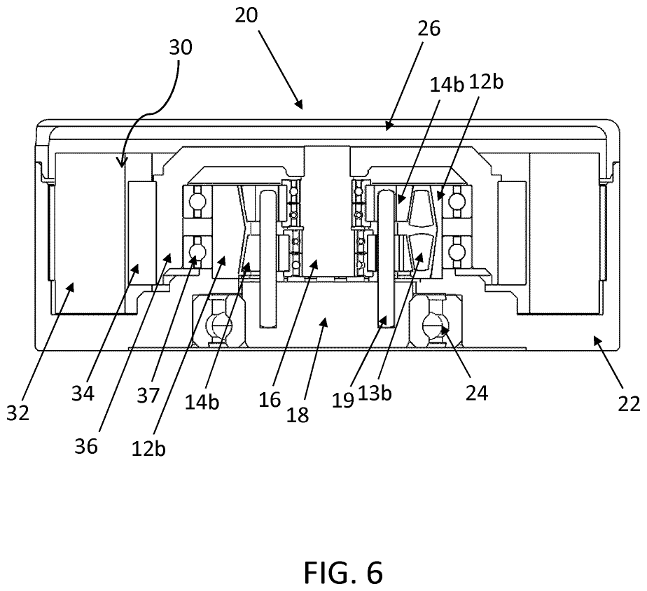

Referring to FIG. 6, in a second alternative embodiment of the high-density actuator 30 with in-motor transmission, the cylindrical roller pins 13 may be replaced by rollers 13b of variable diameter and the shape of the inner part of the cycloidal ring gear 12b and outer face of the cycloid disk 14b adapted to provide corresponding protuberances.

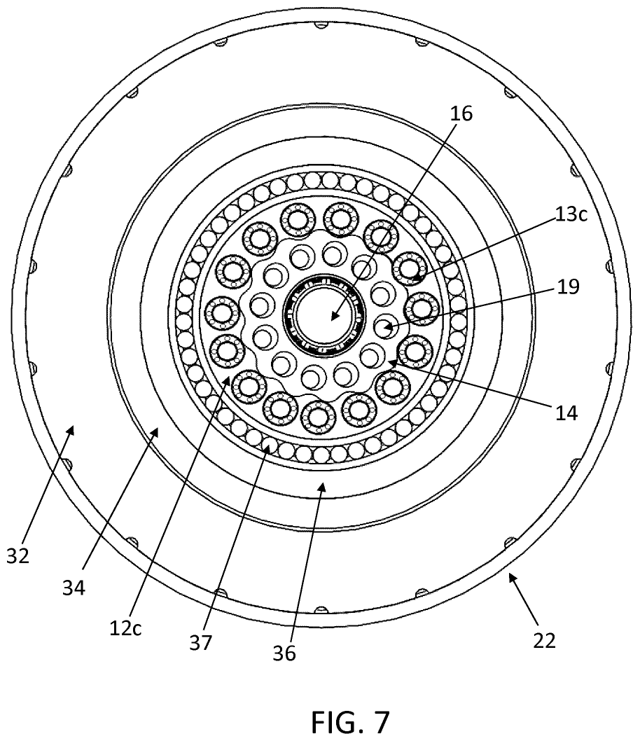

Referring to FIG. 7, in a third alternative embodiment of the high-density actuator 30 with in-motor transmission, the cylindrical roller pins 13 may be replaced by bearings 13c and the shape of the inner part of the cycloidal ring gear 12c adapted to provide structural support for the bearings.

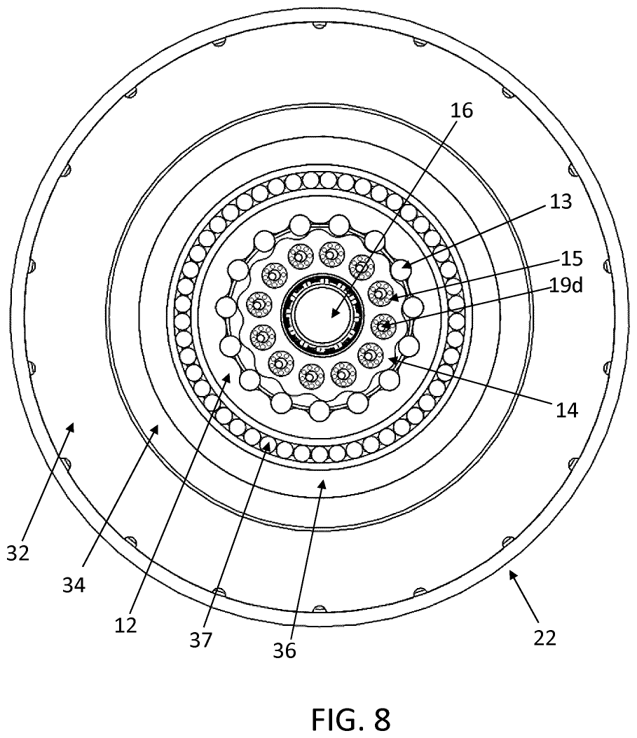

Referring to FIG. 8, in a fourth alternative embodiment of the high-density actuator 30 with in-motor transmission, the cycloid disks 14 may have rolling elements 15 such as bearings inserted between cycloid disk 14 and output pins 19d to transmit the rotational movement of the cycloid disk 14 to the output pins 19d with lower friction.

Although the present disclosure has been described by way of particular non-limiting illustrative embodiments and examples thereof, it should be noted that it will be apparent to persons skilled in the art that modifications may be applied to the present particular embodiment without departing from the scope of the present disclosure.

1. A high-density actuator, comprising:
a motor including a stator (32), a rotor (34), a rotor hub (36), rotor bearings (37), an actuator base (22), and rolling bearings (24); and
a transmission positioned within the rotor hub (36);
wherein the transmission is located within an inner diameter of the motor.

2. The high-density actuator of claim 1, wherein the transmission has an overall diameter that is smaller than an inner diameter of the stator (32) and of an inner diameter of the rotor (34).

3. The high-density actuator of claim 1, wherein the transmission is selected from a group consisting of a cycloidal transmission, a planetary transmission and a harmonic transmission.

4. The high-density actuator of claim 1, wherein the transmission (12, 13, 14, 16, 18, 19) is a cycloidal transmission including:
a cycloid ring gear (12) configured to rotate within the rotor hub (36) via the rotor bearings (37);
an input shaft (16) configured to follow an eccentric motion guided by a cycloid disk (14) having an outer-face configured to roll within the cycloid ring gear (12) via roller pins (13); and
output pins (19), positioned in corresponding openings within the cycloid disk (14), operatively connecting the cycloid disk (14) to an output shaft (18), transferring torque from the rotor (34) to the output shaft (18), further operatively connected to the actuator base (22) via the rolling bearings (24).

5. The high-density actuator of claim 1, wherein the transmission (12a, 14a, 16, 18, 19) is a cycloidal transmission including:
a cycloid ring gear (12) configured to rotate within the rotor hub (36) via the rotor bearings (37);
an input shaft (16) configured to follow an eccentric motion guided by a cycloid disk (14a) having an outer-face configured to roll within the cycloid ring gear (12a) via corresponding protuberances; and
output pins (19), positioned in corresponding openings within the cycloid disk (14a), operatively connecting the cycloid disk (14a) to an output shaft (18), transferring torque from the rotor (34) to the output shaft (18), further operatively connected to the actuator base (22) via the rolling bearings (24).

6. The high-density actuator of claim 1, wherein the transmission (12b, 13b, 14b, 16, 18, 19) is a cycloidal transmission including:
a cycloid ring gear (12b) configured to rotate within the rotor hub (36) via the rotor bearings (37);
an input shaft (16) configured to follow an eccentric motion guided by a cycloid disk (14b) having an outer-face configured to roll within the cycloid ring gear (12b) via roller (13b) having variable respective diameters; and
output pins (19), positioned in corresponding openings within the cycloid disk (14b), operatively connecting the cycloid disk (14b) to an output shaft (18), transferring torque from the rotor (34) to the output shaft (18), further operatively connected to the actuator base (22) via the rolling bearings (24).

7. The high-density actuator of claim 1, wherein the transmission (12c, 13c, 14, 16, 18, 19) is a cycloidal transmission including:
a cycloid ring gear (12c) configured to rotate within the rotor hub (36) via the rotor bearings (37);
an input shaft (16) configured to follow an eccentric motion guided by a cycloid disk (14c) having an outer-face configured to roll within the cycloid ring gear (12c) via bearings (13c); and
output pins (19), positioned in corresponding openings within the cycloid disk (14c), operatively connecting the cycloid disk (14c) to an output shaft (18), transferring torque from the rotor (34) to the output shaft (18), further operatively connected to the actuator base (22) via the rolling bearings (24).

8. The high-density actuator of claim 1, wherein the transmission (12, 13, 14, 15, 16, 18, 19d) is a cycloidal transmission including:
a cycloid ring gear (12) configured to rotate within the rotor hub (36) via the rotor bearings (37);
an input shaft (16) configured to follow an eccentric motion guided by a cycloid disk (14) having an outer-face configured to roll within the cycloid ring gear (12) via bearings (13); and
output pins (19d), positioned in corresponding rolling elements (15) within corresponding openings within the cycloid disk (14), operatively connecting the cycloid disk (14) to an output shaft (18), transferring torque from the rotor (34) to the output shaft (18), further operatively connected to the actuator base (22) via the rolling bearings (24).

9. The high-density actuator of claims 1, wherein the actuator base (22) forms a bottom part of an actuator housing (20), the high-density actuator being enclosed within the actuator housing (20).

10. The high-density actuator of claim 9, further comprising a housing cover (26) securing the high-density actuator within the actuator housing (20).

11. The high-density actuator of claim 2, wherein the transmission is selected from a group consisting of a cycloidal transmission, a planetary transmission and a harmonic transmission.

12. The high-density actuator of claim 2, wherein the transmission (12, 13, 14, 16, 18, 19) is a cycloidal transmission including:
a cycloid ring gear (12) configured to rotate within the rotor hub (36) via the rotor bearings (37);
an input shaft (16) configured to follow an eccentric motion guided by a cycloid disk (14) having an outer-face configured to roll within the cycloid ring gear (12) via roller pins (13); and
output pins (19), positioned in corresponding openings within the cycloid disk (14), operatively connecting the cycloid disk (14) to an output shaft (18), transferring torque from the rotor (34) to the output shaft (18), further operatively connected to the actuator base (22) via the rolling bearings (24).

13. The high-density actuator of claim 2, wherein the transmission (12a, 14a, 16, 18, 19) is a cycloidal transmission including:
a cycloid ring gear (12) configured to rotate within the rotor hub (36) via the rotor bearings (37);
an input shaft (16) configured to follow an eccentric motion guided by a cycloid disk (14a) having an outer-face configured to roll within the cycloid ring gear (12a) via corresponding protuberances; and
output pins (19), positioned in corresponding openings within the cycloid disk (14a), operatively connecting the cycloid disk (14a) to an output shaft (18), transferring torque from the rotor (34) to the output shaft (18), further operatively connected to the actuator base (22) via the rolling bearings (24).

14. The high-density actuator of claim 2, wherein the transmission (12b, 13b, 14b, 16, 18, 19) is a cycloidal transmission including:
a cycloid ring gear (12b) configured to rotate within the rotor hub (36) via the rotor bearings (37);
an input shaft (16) configured to follow an eccentric motion guided by a cycloid disk (14b) having an outer-face configured to roll within the cycloid ring gear (12b) via roller (13b) having variable respective diameters; and
output pins (19), positioned in corresponding openings within the cycloid disk (14b), operatively connecting the cycloid disk (14b) to an output shaft (18), transferring torque from the rotor (34) to the output shaft (18), further operatively connected to the actuator base (22) via the rolling bearings (24).

15. The high-density actuator of claim 2, wherein the transmission (12c, 13c, 14, 16, 18, 19) is a cycloidal transmission including:
a cycloid ring gear (12c) configured to rotate within the rotor hub (36) via the rotor bearings (37);
an input shaft (16) configured to follow an eccentric motion guided by a cycloid disk (14c) having an outer-face configured to roll within the cycloid ring gear (12c) via bearings (13c); and
output pins (19), positioned in corresponding openings within the cycloid disk (14c), operatively connecting the cycloid disk (14c) to an output shaft (18), transferring torque from the rotor (34) to the output shaft (18), further operatively connected to the actuator base (22) via the rolling bearings (24).

16. The high-density actuator of claim 2, wherein the transmission (12, 13, 14, 15, 16, 18, 19d) is a cycloidal transmission including:
a cycloid ring gear (12) configured to rotate within the rotor hub (36) via the rotor bearings (37);
an input shaft (16) configured to follow an eccentric motion guided by a cycloid disk (14) having an outer-face configured to roll within the cycloid ring gear (12) via bearings (13); and
output pins (19d), positioned in corresponding rolling elements (15) within corresponding openings within the cycloid disk (14), operatively connecting the cycloid disk (14) to an output shaft (18), transferring torque from the rotor (34) to the output shaft (18), further operatively connected to the actuator base (22) via the rolling bearings (24).

17. The high-density actuator of claim 2, wherein the actuator base (22) forms a bottom part of an actuator housing (20), the high-density actuator being enclosed within the actuator housing (20).

18. The high-density actuator of claim 17, further comprising a housing cover (26) securing the high-density actuator within the actuator housing (20).
